(19) United States
(12) Patent Application Publication
(10) Pub. No.: US 2025/0385625 A1
(43) Pub. Date: Dec. 18, 2025

(54) MATRIX MOTOR BASED ON MIRROR SYMMETRY PRINCIPLE

(71) Applicant: SHENZHEN INSTITUTES OF ADVANCED TECHNOLOGY CHINESE ACADEMY OF SCIENCES, Shenzhen (CN)

(72) Inventor: Tianfu SUN, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 19/173,487

(22) Filed: Apr. 8, 2025

(30) Foreign Application Priority Data
Jun. 13, 2024 (CN) 202410762393.3

(51) Int. Cl. H02P 5/753

(52) U.S. Cl. CPC H02P 5/753

(57) ABSTRACT

A matrix motor based on mirror symmetry principle includes several motor elements. The motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; two motor elements that are symmetrical about a mirror axis in the matrix motor are opposite types. The application solves the problems of the existing matrix motor, such as weak mutual coupling of all matrix motors, weak output torque, insufficiently compact arrangement, and imperfect electromagnetic scheme among all motor elements.

### CROSS-REFERENCE TO RELATED APPLICATIONS

This application claims priority to Chinese Patent Application No. 202410762393.3, filed on Jun. 13, 2024, the content of which is incorporated herein by reference in its entirety.

### TECHNICAL FIELD

The application relates to the technical field of motors, in particular to a matrix motor based on mirror symmetry principle.

### BACKGROUND

The most important characteristics of a motor performance are the torque density and power density of the motor (that is, the ratio of the torque/power of the motor to the volume of the motor, or the ratio of the torque/power of the motor to the weight of the motor). In order to increase the torque/power density of a motor, permanent magnets are installed on the rotor, and the magnetic field of the permanent magnet is superimposed with the magnetic field generated by the motor stator winding, thus the torque of the motor can be further increased. However, the magnetic field generated by the permanent magnet is limited by the properties of the permanent magnet material. In addition, there are limits on the magnetic permeabilities of stator and rotor iron cores (silicon steel), and a large magnetic field density may cause the silicon steel's magnetic path saturate, making it impossible to further increase the magnetic field. Therefore, this technique has limited improvements on the torque/power density of motors. The torque/power density of a motor also can be improved by increasing the number of rotor magnetic poles or increasing the currents in the motor windings. However, due to the limited rotor space, the number of magnetic poles could not be too large, and the current in the motor winding may be too large to burn the stator winding, therefore, the motor current is also limited. These limits further limit motor torque/power density.

The coupling of each motor element in the existing matrix motor is mainly based on the “magnetic field components synthesis principle”, that is, a portion of phase winding's magnetic field of the first motor element is in phase with its adjacent windings of the second motor element and vice versa to realize the enhancement of the magnetic fields between the two motor elements and realize magnetic circuit coupling. However, the existing matrix motor has some limits, such as weak coupling between motor elements (only coupling of magnetic field components, unable to fully achieve magnetic field coupling), weak output torque, the motor element arrangement is not compact, complex transmission mechanism of each motor element, and the electromagnetic scheme among all motor elements is imperfect.

### SUMMARY

The embodiments of the application provide a matrix motor based on a mirror symmetry principle, which solves the problems of the existing motor elements, such as weak mutual coupling of all matrix motors, weak output torque, insufficiently compact arrangement, complex transmission mechanism of all motor elements, and imperfect electromagnetic scheme among all motor elements.

In order to solve the above technical problem, the embodiments of the present application provide a matrix motor based on a mirror symmetry principle, which comprises several motor elements; wherein the motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; all the motor elements are spliced and arranged to form a matrix motor, and two motor elements that are symmetrical about a mirror axis in the matrix motor are with opposite types.

In some exemplary embodiments, each motor element in the matrix motor is of opposite type with respect to its adjacent motor element, and each motor element in the matrix motor is of the same type as its diagonal motor element.

In some exemplary embodiments, the exterior outline of a motor element is square or rectangular; and the exterior outline of a matrix motor formed by several mutually spliced motor elements is a rectangle or a combination of several rectangles.

In some exemplary embodiments, the mirror axis mirrors the Type B motor element stator part into the Type A motor element stator part, or mirrors the Type A motor element stator part into the Type B motor element stator part, and through the synthesis and coupling of the magnetic field generated by each motor element in the matrix motor, some stator yokes can be removed and the output torque of the rotor can be increased at the same time.

In some exemplary embodiments, the stator part of a motor element is formed by encircling several half-teeth of the motor element stator; a motor element stator's half-tooth slot is between two motor element stators' half-teeth; several half-teeth of a motor element are enclosed to form a stator-module with a circular hole inside and a square or a rectangular exterior outline, and the motor rotor is enclosed at the center of the stator-module; and the stator-module enclosed by half-teeth of the motor element is coaxial with the rotor.

In some exemplary embodiments, the motor element further comprises a front end-cover, a rear end-cover, a front bearing, a rear bearing and a set of motor element winding, wherein the motor element winding is divided into several phases and wrapping on half-teeth of the motor element; the front end-cover and the rear end-cover also can be provided with end-cover protruding parts, and the end-cover protruding parts can be inserted into half-tooth slots of the motor element to realize the mutual fixation among the front end-cover, the rear end-cover and different half-teeth; and the front and rear bearings are set in the cavities in the front end-cover and the rear end-cover respectively to realize the free rotation of the rotor around the shaft and limit the rotor radial and axial positions.

In some exemplary embodiments, the motor element phase windings' magnetic field directions of the corresponding windings in Type B and Type A motor elements are opposite with respect to their rotors when the forward current of the matrix motor is applied to the windings; and the Type B and Type A motor elements' rotor rotation directions are opposite to each other; and when the rotors' magnetic poles of motor elements are all aligned with A-phase at the initial state, the rotor pole polarities in Type B and Type A motor elements aligned with A-phase are opposite.

In some exemplary embodiments, the connection mode of each phase winding of each motor element can be series connection, parallel connection or series-parallel connection.

In some exemplary embodiments, after each motor element is symmetrical about a mirror axis, the motor element can rotate around the mirror axis by a certain angle in space to realize a spatial structure; and magnetic conductive materials are arranged between the half-teeth of the two adjacent motor elements to realize the coupling of the magnetic fields of the two motor elements.

In some exemplary embodiments, the motor elements are matched and synchronized with each other by means of gears, magnetic gears, magnetic coupling, belt pulleys, friction or chains, so that the torques of the motor elements are gathered together to realize the synchronous rotation of the motor element rotors.

The technical solution provided by the embodiments of the present application at least has the following advantages.

The embodiments of the present application provide a matrix motor based on a mirror symmetry principle, which comprises several motor elements; wherein the motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; all the motor elements are spliced and arranged to form a matrix motor, and two motor elements that are symmetrical about a mirror axis in the matrix motor are with opposite types. The application provides a novel matrix motor topological structure based on a mirror symmetry principle, aiming at the problems of the existing matrix motor that the mutual coupling of motor elements is weak (only coupling of magnetic field components, unable to fully achieve magnetic field coupling), the output torque is weak, the arrangement is not compact enough, complex transmission mechanism of each motor element, and the electromagnetic scheme among all motor elements is imperfect. The topological structure of the invented matrix motor has the advantages of compact structure, strong coupling, large output torque and simple transmission, and the production and control of the matrix motor are simpler and more convenient by optimizing the electromagnetic scheme between the motor elements.

### BRIEF DESCRIPTION OF THE DRAWINGS

One or more embodiments are illustrated by way of example in the accompanying drawings, which do not constitute limitations on the embodiments, and the figures in the drawings do not constitute limitations on the scale unless otherwise specified. In the drawings:

FIG. 1 is a structural diagram of a conventional 3-slot 2-pole motor;

FIG. 2 is a schematic diagram of the “magnetic field components synthesis principle” of the matrix motor in the related technologies;

FIG. 3 is a schematic diagram of a conventional 3-phase 2-pole motor;

FIG. 4 is a schematic diagram of a 3-phase 2-pole motor element module provided by an embodiment of the present application;

FIG. 5A is a schematic diagram of a Type B motor element provided by an embodiment of the present application;

FIG. 5B is a schematic diagram of a Type A motor element provided by an embodiment of the present application;

FIG. 6 is a schematic diagram of the most fundamental matrix motor provided by the embodiments of the present application;

FIG. 7 is a schematic diagram of a matrix motor composed of 8 motor elements according to an embodiment of the present application;

FIG. 8 is a schematic diagram of the parallel connection method of each phase of the matrix motor provided by the embodiments of the present application;

FIG. 9 is a schematic diagram of a method for connecting the phases of a matrix motor in series according to an embodiment of the present application;

FIG. 10 is a schematic diagram of a Type A motor element and a Type B motor element with 4-pole 6-slot according to an embodiment of the present application;

FIG. 11 is a schematic diagram of a matrix motor composed of 4-pole 6-slot motor elements according to an embodiment of the present application;

FIG. 12A is a schematic diagram of a 4-pole 24-slot Type A motor element provided in an embodiment of the present application;

FIG. 12B is a schematic diagram of a 4-pole 24-slot Type B motor element provided in an embodiment of the present application;

FIG. 13 is a schematic diagram of a matrix motor composed of 4-pole 24-slot motor elements according to an embodiment of the present application;

FIG. 14 is a schematic structural diagram of a motor element provided by an embodiment of the present application;

FIG. 15A is an exploded view of the motor element structure provided by the embodiments of the present application;

FIG. 15B is a sectional view of a motor element structure provided by an embodiment of the present application;

FIG. 16 is a schematic diagram of a matrix motor module according to an embodiment of the present application;

FIG. 17 is a schematic diagram of a 10-pole 12-slot Type A and Type B motor elements splicing scheme and a part of windings provided by an embodiment of the present application;

FIG. 18 is a half sectional view of the matrix motor provided by the embodiments of the present application;

FIG. 19 is a schematic diagram of a square matrix motor gear drive scheme provided by an embodiment of the present application;

FIG. 20 is a schematic diagram of a square or a rectangular matrix motor gear drive scheme provided by an embodiment of the present application;

FIG. 21 is an example diagram of the rotation direction of each motor element of the matrix motor provided by the embodiments of the present application; and

FIG. 22 is an example of a spatial structure formed by rotating the motor element stator module of the matrix motor around the mirror axis by a certain angle according to the embodiments of the present application.

### DETAILED DESCRIPTION OF THE EMBODIMENTS

According to the background technology, the existing matrix motors based on the principle of “magnetic field components synthesis principle” have some problems, such as weak coupling between motor elements, weak output torque, the motor element arrangement is not compact, complex transmission mechanism of each motor element, and the electromagnetic scheme among all motor elements is imperfect.

The cross-section schematic of the basic structure of an existing motor is shown in FIG. 1. Taking a three-phase 3-slot 2-pole motor as an example, the motor is composed of a stator and a rotor, the stator is provided with stator teeth 10, stator slots 11 are arranged between the stator teeth 10, the stator teeth 10 are connected through a stator yoke 12, windings 2 are arranged in the stator slots 11 wrapping around stator teeth 10, and the rotor is provided with rotor magnetic poles 14 and a rotor iron core 15. The stator generates a rotating magnetic flux by applying alternating current to each winding of the stator, and the rotating magnetic field attracts the motor rotor to rotate generating torque.

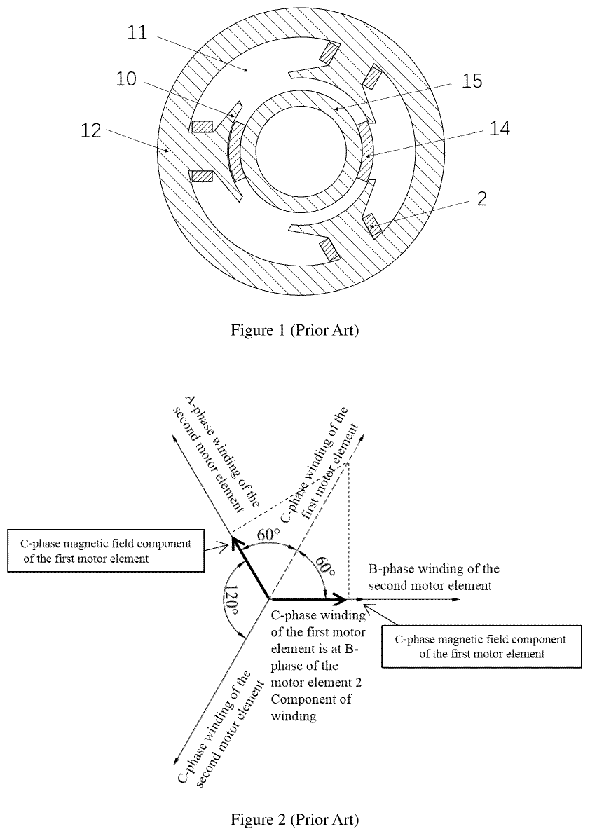

In order to improve the torque density of the motor, a matrix motor is proposed in the related technologies. The matrix motor is composed of several motor elements, and the motor elements are mainly arranged in a triangular shape; the main structure of the matrix motor comprises private stator yokes, private stator teeth arranging on the private stator yokes, private windings wrapping on the private stator teeth, public stator yokes, public stator teeth arranged on the public stator yokes, public windings wrapping on the public stator teeth, and several rotors corresponding to the private stator teeth and/or the public stator teeth. The coupling of each motor element of the matrix motor is mainly based on the “magnetic field components synthesis principle”, that is, a portion of a phase winding's magnetic field of the first motor element is in phase with its adjacent windings of the second motor element and vice versa to realize the enhancement of the magnetic fields between the two motor elements and realize magnetic circuit coupling. The “magnetic field components synthesis principle” of the matrix motor is shown in FIG. 2. The magnetic field projection components of the C-phase winding of the first motor element on the A-phase winding of the second motor element and the B-phase winding of the second motor element are same with their magnetic field directions, thus the magnetic field of the first motor element on the second motor element can be enhanced, and the magnetic circuit coupling can be realized.

However, the matrix motors based on the principle of “magnetic field components synthesis principle” have some problems, such as weak coupling between motor elements, weak output torque, the arrangement is not compact enough, complex transmission mechanism of each motor element, and the electromagnetic scheme among all motor elements is imperfect. In order to solve the above technical problem, the embodiments of the present application provide a matrix motor based on a mirror symmetry principle, which comprises several motor elements; wherein the motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; all the motor elements are spliced and arranged to form a matrix motor, and two motor elements that are symmetrical about a mirror axis in the matrix motor are with opposite types. The application provides a novel matrix motor topological structure based on a mirror symmetry principle, and the novel matrix motor topological structure has the advantages of compact structure, strong coupling property, large output torque and simple transmission, and the matrix motor is simpler and more convenient to produce and control by optimizing the electromagnetic scheme among motor elements.

The embodiments of the present application will be described in detail below with reference to the drawings. However, one of ordinary skill in the field can appreciate that in the various embodiments of the present application, many technical details are set forth in order for the reader to better understand the present application. Even without such technical details and various changes and modifications based on the following embodiments, the technical scheme claimed in the present application can be realized.

Referring to FIGS. 4-21, the embodiments of the present application provide a matrix motor based on a mirror symmetry principle, which comprises several motor elements; wherein the motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; all the motor elements are spliced and arranged to form a matrix motor, and two motor elements that are symmetrical about a mirror axis in the matrix motor are with opposite types.

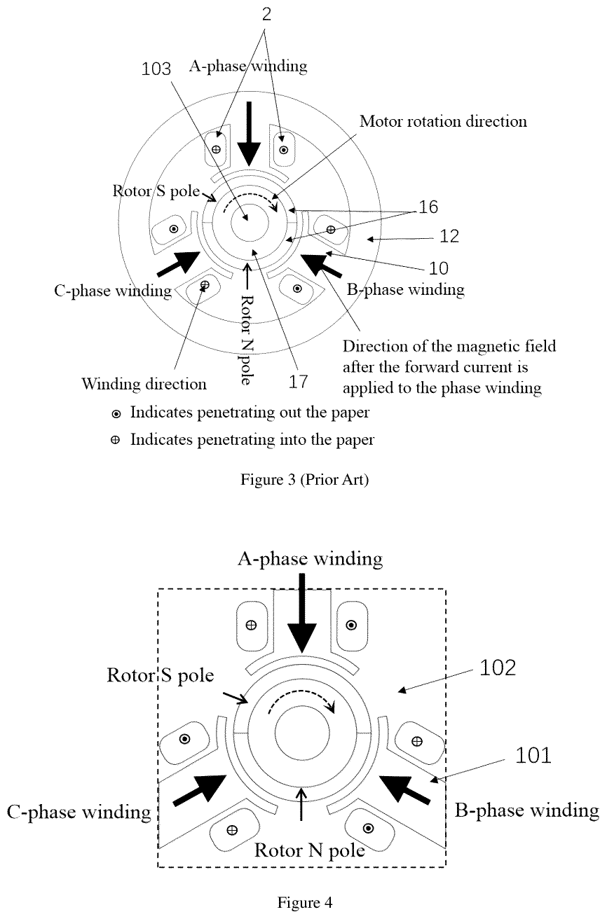

A conventional 3-phase 2-pole motor is shown in FIG. 3. The conventional 3-phase 2-pole motor is composed of a rotor shaft 103, a three-phase winding 2 (an A-phase winding, a B-phase winding, and a C-phase winding), rotor permanent magnets 16, stator teeth 10, a stator yoke 12, a motor rotor iron core 17, and the like. A rotating magnetic field is generated in the stator of the motor to drive the rotor of the motor to rotate when three-phase alternating currents with different phase shifts are applied to the A-, B- and C-phases of the motor. It should be noted that the stator yoke 12 is usually made of silicon steel with good magnetic permeability to form a magnetic flux path for passing the magnetic field generated by the phase windings and teeth of the motor. Although the stator yoke 12 occupies a large portion of the weight and volume of a motor, the stator yoke 12 only provides a magnetic flux path and does not participate in the magnetic field energy and electric energy conversion. Therefore, the stator yoke 12 is essentially not directly related to the torque generation of the motor.

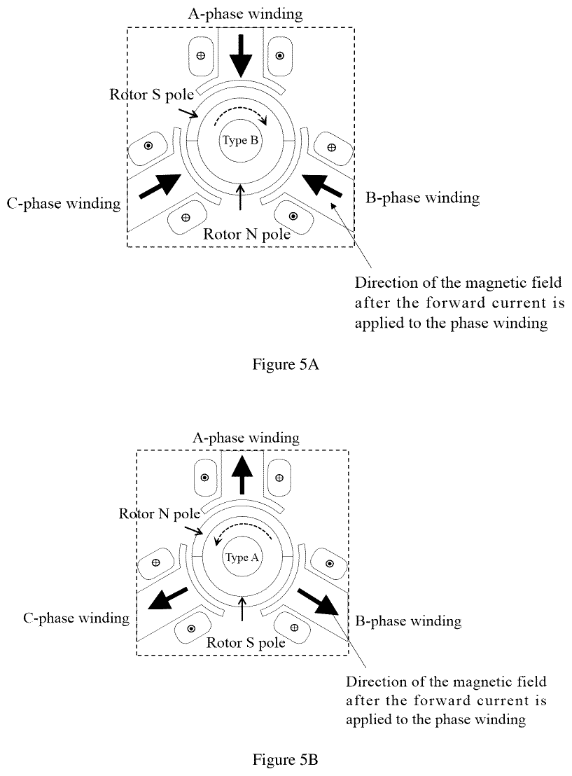

If the stator yoke 12 is removed and the exterior outline of the motor is made into a rectangle, the motor element proposed in the embodiments of the present application is obtained, as shown in FIG. 4, 101 is a stator's half-tooth of the motor element, and 102 is a stator's half-tooth slot of the motor element. In the present application, the stator's half-tooth 101 is obtained by removing the stator yoke and shaping the exterior outline of the stator into a rectangle, and the gap between two motor element half-teeth 101 is a motor element's half-tooth slot 102. Further, the motor element shown in FIG. 4 is further divided into two types according to the motor element winding generated magnetic field direction with respect to the rotor of the motor element when the forward current of the matrix motor is applied to the windings, that is, the two types of motor elements are named Type B motor element and Type A motor element respectively, and the Type B motor element and the Type A motor element are shown in FIGS. 5A and 5B respectively.

As shown in FIGS. 5A and 5B, when the forward current of the matrix motor is applied to the corresponding phase windings of the Type B motor element and the Type A motor element, the resultant magnetic field directions (referred to as ‘forward magnetic fields’) of the two types of motor elements are opposite with respect to their rotor (that is, the forward magnetic fields of the ‘Type B’ motor element flow into its rotor, and the forward magnetic fields of the ‘Type A’ motor element flow out of its rotor), the Type B and Type A motor elements' rotor rotation directions are opposite to each other, and when the rotors' magnetic poles of motor elements are all aligned with A-phase at the initial state, the rotor pole polarities in Type B and Type A motor elements aligned with A-phase are opposite.

In some embodiments, each motor element in the matrix motor is of opposite type with respect to its adjacent motor element, and each motor element in the matrix motor is of the same type as its diagonal motor element.

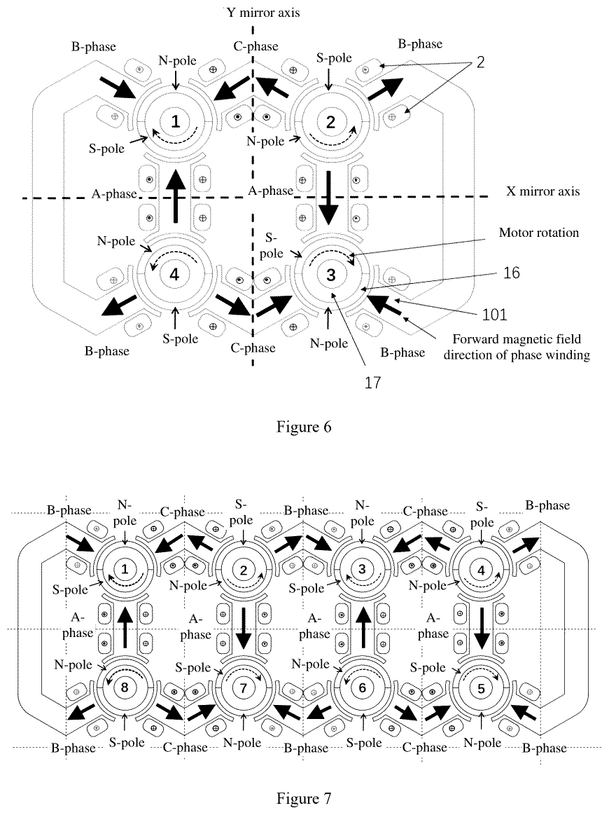

If two ‘Type B’ motor elements and two ‘Type A’ motor elements numbered 1-4 are alternately arranged (odd numbers are ‘Type B’ and even numbers are ‘Type A’), the most fundamental matrix motor shown in FIG. 6 can be obtained.

In FIG. 6, 101 is a half stator tooth of a motor element, 2 is a winding, 16 is a rotor permanent magnet, and 17 is a motor rotor iron core. As shown in FIG. 6, each motor element of the matrix motor composed of the motor elements of the present application is of opposite type of its neighboring motor elements, that is, each ‘Type B’ motor element is adjacent to a ‘Type A’ motor element, and each ‘Type A’ motor element is also adjacent to a ‘Type B’ motor element. The two motor elements with the same type are located at diagonally corners of each other. Any motor element symmetrical about the X or Y mirror axis is of the opposite type of motor element, for example, the motor element 1 is ‘Type B’, and the motor elements symmetrical about the X or Y mirror axis are ‘Type A’.

In some embodiments, the mirror axis mirrors the Type B motor element stator part into the Type A motor element stator part, or mirrors the Type A motor element stator part into the Type B motor element stator part, and through the synthesis and coupling of the magnetic field generated by each motor element in the matrix motor, some stator yokes can be removed and the output torque of the rotor can be increased at the same time.

By observing FIG. 6, it can be seen that the mirror axis is like a mirror, mirrors the ‘Type B’ motor element stator part into the ‘Type A’ motor element stator part, and vice versa, so this principle is called the ‘mirror symmetry principle’. For example, the directions of A-, B- and C-phase windings in motor elements are illustrated by penetrating in or out of the paper surface. As illustrated in FIG. 6, directions of A-, B- and C-phase windings penetrating the paper surface, the phase winding sequence, the rotor rotation direction of the motor element 2 and 4 are all mirror images of these of motor element 1 about the Y or X mirror axes. However, after the mirroring, the rotor magnetic poles' polarity is reversed. For example, although the motor element 4 is a mirror image of motor element 1 about the X mirror axis, the rotor pole polarity of motor element 4 is reversed after the mirroring.

As the motor elements are arranged base on the mirror symmetry principle, the magnetic fields generated by the windings of the motor element can be completely coupled with each other at any time, for example, the A-phase winding of the motor element 4 and the A-phase winding of the motor element 1 are coupled with each other, and the forward magnetic field flowing directions of the windings are same. The C-phase winding of motor element 1 and the C-phase winding of motor element 2 are fully coupled with each other, and the forward magnetic field flowing directions of the windings are same. Therefore, the magnetic fields generated by each motor element of the matrix motor according to mirror symmetry principle can be completely superposed and coupled with each other, which not only realizes the removal of the stator yoke, but also further increases the output torque of the rotor. It should be noted that the motor element coupling mode based on the “mirror symmetry principle” provided by the present application is complete coupling, which is different from the motor elements' magnetic field components coupling based on the principle of “magnetic field components synthesis principle” in the related technologies.

In some embodiments, the exterior outline of a motor element is square or rectangular; and the exterior outline of the matrix motor formed by mutually splicing and arranging several motor elements is square or rectangular. Further, through the combination and splicing the motor elements, a matrix motor with varieties of exterior outlines can be obtained. As shown in FIG. 7, a square or a rectangular matrix motor can be obtained by arranging and combining 8 motor units according to the above principle of mirror symmetry.

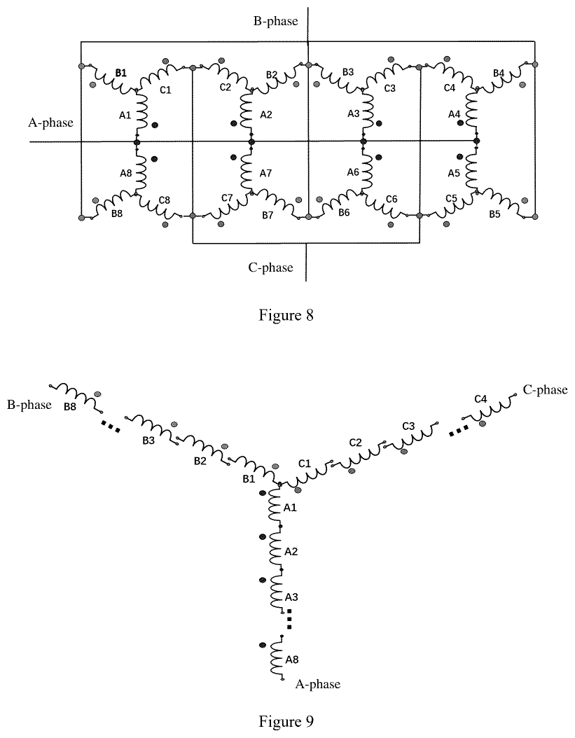

According to the above “mirror symmetry principle”, the connection mode of each phase winding among motor elements can be connected in series, parallel or series-parallel. As shown in FIG. 8, if the corresponding phase windings of each motor element in FIG. 7 are connected in parallel, the starting ends of each related phase winding are connected together. As shown in FIG. 8, the motor elements under parallel connection are still mirror symmetric about multiple mirror axes. As shown in FIG. 9, if the corresponding phase windings of each motor element in FIG. 7 are connected in series, the starting end of a phase winding is connected to the finishing end of the corresponding phase of another motor element.

In addition, the motor elements can be divided into groups according to whether they are connected in series or in parallel, and a group of the motor elements can be connected in parallel or in series with other motor element groups, to realize the series-parallel hybrid connection.

Based on the mirror symmetry principle, the matrix motor design principle proposed in this application can be summarized as follows.

Firstly, the exterior outline of a motor element is square or rectangular, and the motor element types are classified into the Type B motor elements and the Type A motor elements. The directions of the forward magnetic fields of the corresponding phase windings in a Type B motor element and a Type A motor element are opposite with respect to their rotors respectively, the Type B and Type A motor elements' rotor rotation directions are opposite to each other, and when the rotors' magnetic poles of motor elements are all aligned with A-phase at the initial state, the rotor pole polarities in Type B and Type A motor elements aligned with A-phase are opposite.

Secondly, several ‘Type B’ and ‘Type A’ motor elements can be mutually spliced and arrange into a matrix motor. Each motor element in the matrix motor is of opposite type with respect to its adjacent motor element, and each motor element in the matrix motor is of the same type as its diagonal motor element.

Lastly, the square or rectangular exterior outline edge where two motor elements are spliced can be a mirror axis of the matrix motor, and the two motor elements which are symmetrical about the mirror axis are with opposite types. The mirror axis is like a mirror, mirroring the ‘Type B’ motor element stator part into the ‘Type A’ motor element stator part, and vice versa. However, the magnetic pole polarity of the rotor is reversed after being mirrored.

In some embodiments, the motor element can be a 2-pole 3-slot motor element, a 4-pole 6-slot motor element, a 4-pole 24-slot motor element, or a 10-pole 12-slot motor element.

Based on the above principles, examples of motor elements with these motor pole-slot topologies, as well as the matrix motor composed by such motor elements, are as follows.

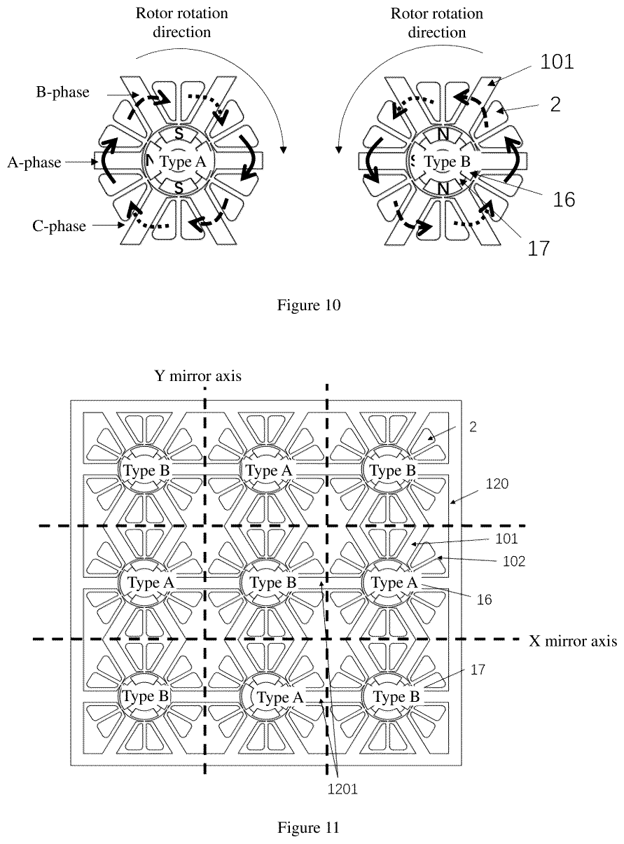

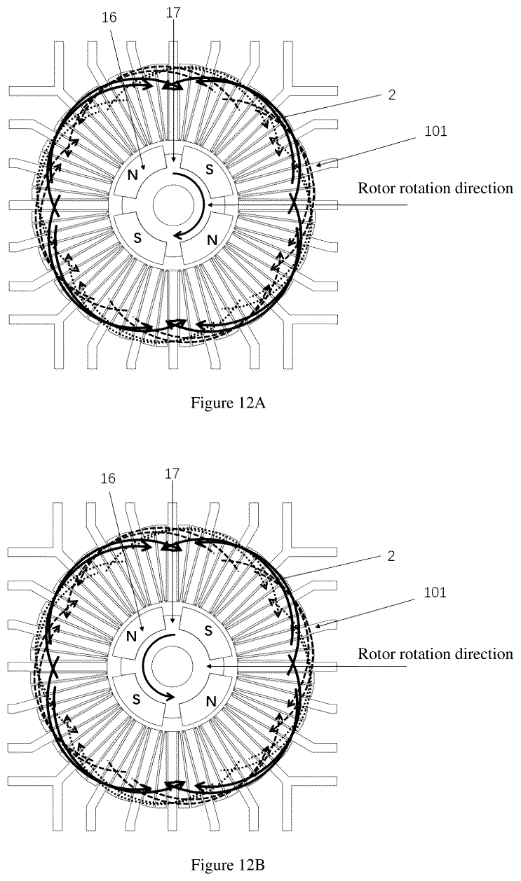

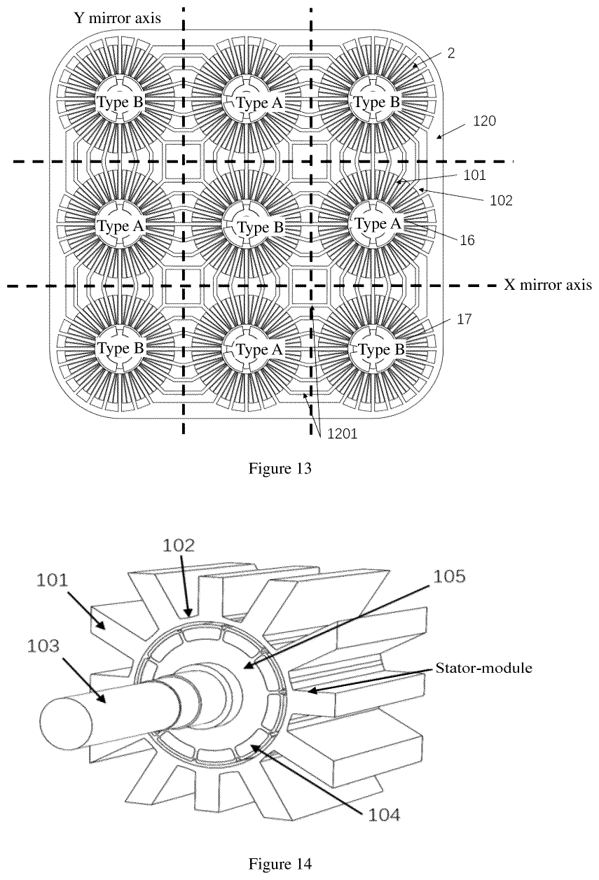

For example, a 4-pole 6-slot motor element is shown in FIG. 10. A matrix motor consisting of the 4-pole 6-slot motor elements shown in FIG. 10 is shown in FIG. 11. Similarly, the 4-pole 24-slot motor element is shown in FIGS. 12A and 12B. A matrix motor consisting of the 4-pole 24-slot motor elements shown in FIGS. 12A and 12B is shown in FIG. 13. 120 is a private stator yoke, and 1201 is a public stator yoke which is constituted by two 101 half teeth.

It can be seen from the above analysis that the motor element and matrix motor structure proposed in this application is applicable to all types of internal rotor motors, and is nether affected by the pole-slot combination nor the topological structure of the motor.

Further, in order to detail the proposed motor element and the matrix motor, the present application further provides a concrete realization scheme of the matrix motor by taking a 10-pole 12-slot motor as an example:

The concrete implementation structure of the proposed motor element is shown in FIG. 14.

As shown in FIG. 14, the stator module of the motor element proposed in the present application is enclosed by several motor element half-teeth 101, and a motor element half-tooth slot 102 is provided between two motor element half-teeth 101. Several half-teeth 101 of the motor elements enclose a stator module with a circular hole inside and a square or a rectangular exterior outline, and the motor rotor is enclosed at the center of the stator module. The stator module enclosed by several half-teeth, is coaxial with the rotor magnetic poles 104 and the rotor shaft 103.

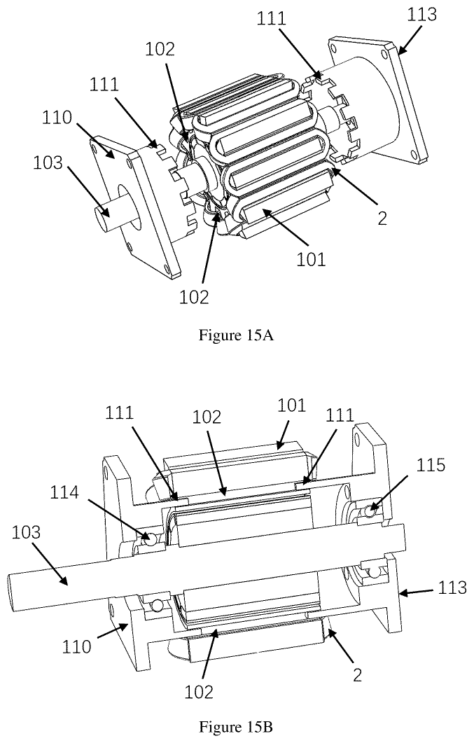

Based on the motor element structure shown in FIG. 14, the exploded view and the cross-sectional view of the motor element structure proposed in the present application are shown in FIGS. 15A and 15B, respectively.

As shown in FIGS. 15A and 15B, the motor element further includes a front end-cover 110, a rear end-cover 113, a front bearing 114, a rear bearing 115, and set of winding 2, wherein the winding 2 (motor element winding) is divided into several phases, and are wrapped on motor element half-teeth 101 same as the conventional motor winding topologies. Similar to the conventional motors, the motor element winding will generate a rotating magnetic field in stator module when alternating currents are passed through the motor element winding phases. The front end-cover 110 and the rear end-cover 113 also can be provided with end-cover protruding parts 111, wherein the end-cover protruding parts 111 can be inserted into the half-tooth slot 102 of the motor element to realize the mutual fixation among the front end-cover 110, the rear end-cover 113 and different stator-teeth; and the front bearings 114 and the rear bearings 115 are set in the cavities in the front end-cover 110 and the rear end-cover 113 respectively to realize the free rotation of the rotor around the shaft and limit the rotor radial and axial positions.

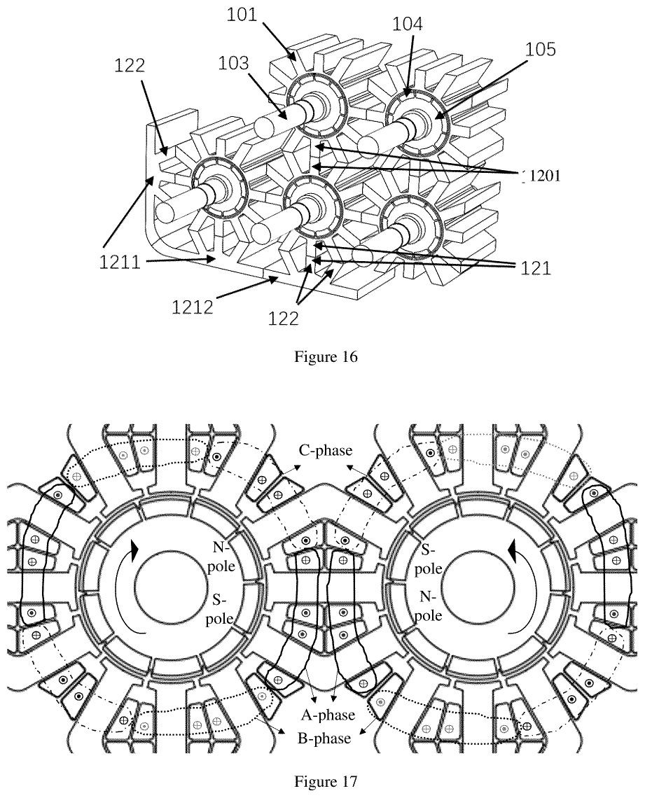

Since the exterior outline of the stator module of the motor element provided by the present application is square or rectangular, several stator modules can be spliced into regular shapes such as square, rectangular, or a combination of square and rectangular (as shown in FIG. 16), or other irregular shapes. In FIG. 16, 121 is a private stator tooth, 122 is a private half-tooth, and the 121 is constituted by a 122 private half-tooth and a 101 half-tooth. 1211 is a first private stator yoke, and 1212 is a second private stator yoke.

In order to close the magnetic circuit loop at the edge of the matrix motor, a private stator yoke is arranged at the edge of the matrix motor, wherein the first private stator yoke 1211 comprises a corner and can be arranged at the corner of the matrix motor; and the second private stator yoke 1212 does not include a corner and can be arranged at the edge of the matrix motor. The private stator yoke may also be provided with private half-tooth 122, and the private half-tooth 122 and the motor element's half-tooth 101 may be spliced to form the private stator tooth 121.

As shown in FIG. 17, several motor elements can be spliced with each other, and half-teeth of two motor elements can be spliced into a public stator tooth. The two mutually spliced motor elements are with opposite motor element types, and the splicing method is similar to the method detailed in FIGS. 11 and 13.

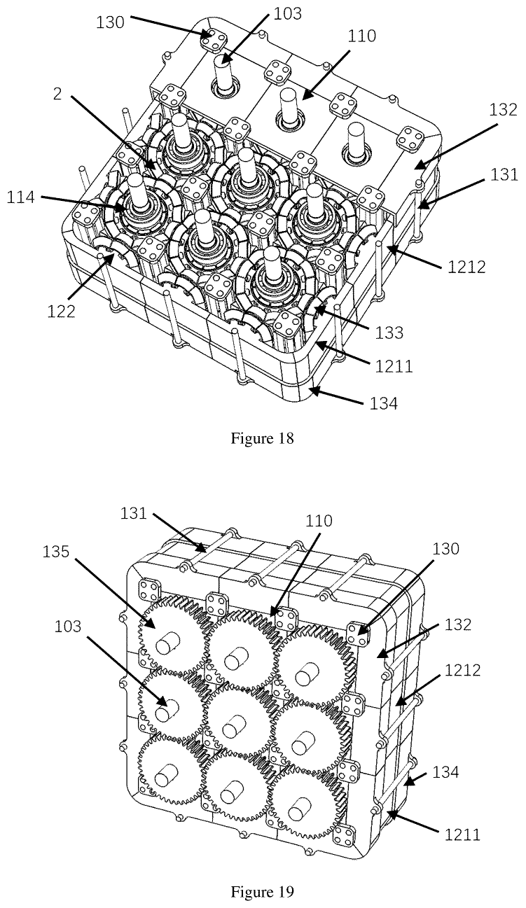

A half-sectional view of the matrix motor embodiment proposed in this application is shown in FIG. 18. Several motor elements are fixed as a whole, that is, a matrix motor, by a motor element fixing element 130, a bolt 131, a motor element front end-cover 110, a motor element rear end-cover (not shown in FIG. 18), a private stator yoke front end-cover 132, and a private stator yoke rear end-cover 134. Each motor element is provided with a motor element winding as shown in FIG. 15A. Each of the first and second private stator yokes 1211, 1212 may be provided with a private stator yoke winding 133 as required, or may not be provided with a private stator yoke winding 133. Several motor element front end-cover 110, a private stator yoke front end-cover 132, etc. may also be integrally formed to increase the strength of the matrix motor. A rear end-cover for several motor elements, a rear end-cover for a private stator yoke, etc. may also be integrated.

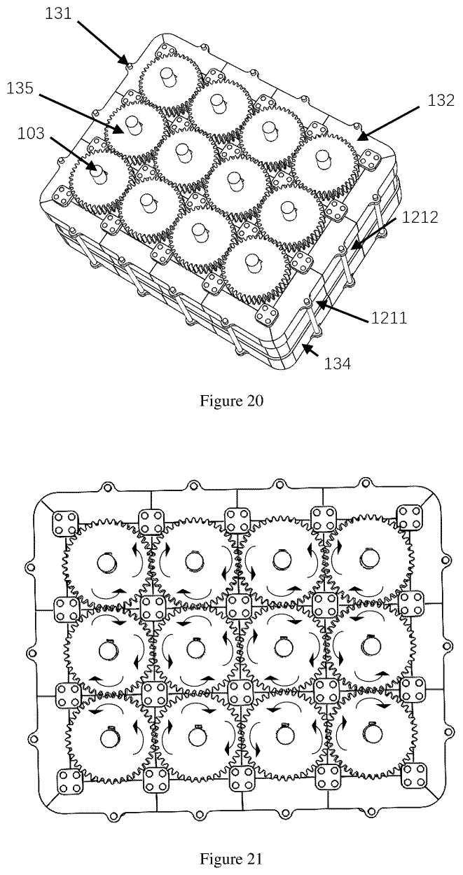

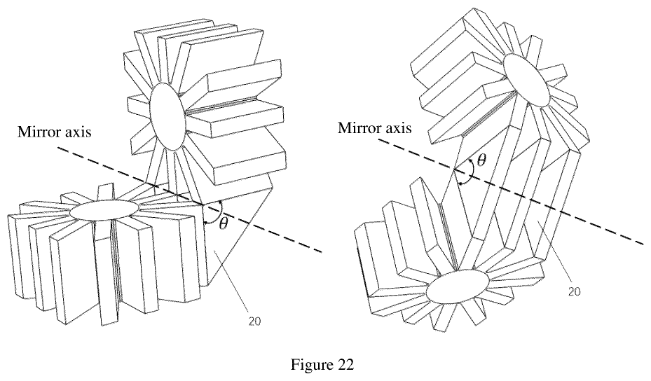

In order to ensure the synchronous rotation of each motor element and gather the torque of each motor element together, each motor element can be matched and synchronized with each other by means of gears, magnetic gears, magnetic couplings, pulleys, friction, chains, etc. The present application takes gear engagement as an example, and the proposed gear engagement scheme is shown in FIGS. 19 and 20, where 134 in FIG. 19 is the rear end-cover of the private stator yoke; Any two adjacent motor elements are engaged by the motor element gear 135, and the rotors of the engaged two adjacent motor elements rotate in opposite directions. Specifically, the rotational direction of each motor element gear 135 is shown in FIG. 21. The gears of various motor elements are engaged with each other, and that torque of the motor can be output by the rotor shaft of any motor element or by several motor element shafts. The shaft used to output the matrix motor torque is called the output shaft. As the torque is driven from the peripheral motor elements to the output shaft, in order to ensure the drive strength, the gear strength can be enhanced by increasing the gear thickness, that is, the gear angle away from the output shaft is thinner, and the closer to the output shaft, the thicker the gear is. Other drives based on pulleys, friction, chains, etc., can also increase the strength of the drive in a similar way.

In order to meet the specific spatial shape requirements, as shown in FIG. 22, the stator module of the motor element can rotate around the mirror axis by a certain angle θ to form a spatial structure; wherein the left figure of FIG. 22 shows the schematic diagram of the motor element stator module rotating around the mirror axis, and the right figure of FIG. 22 shows the filling position of the magnetic conductive material 20. By filling the magnetic permeable material 20 between the two half-teeth, the magnetic field between the two motor elements is circulated.

The matrix motor provided by the application is essentially an electric energy and mechanical energy conversion mechanism which is the same as the motor, and can be widely applied to various fields such as robots, servos, industrial automation and aerospace. In addition, the matrix motor provided by the application has been verified by simulation and experiment, and the result is consistent with the expectation.

Compared with a matrix motor in the related technology, the matrix motor based on a mirror symmetry principle provided by the application has the advantages that on one hand, the matrix motor is based on the mirror symmetry principle, and motor elements are divided into Type B motor elements and Type A motor elements which are symmetrically arranged about a mirror axis. Therefore, the motor elements of the matrix motor system are arranged in a square or rectangular manner, and each motor element is located at the four corners of the rectangle. On the other hand, the application provides the structure topologies and design principle of the Type B motor element and the Type A motor element, and provides a novel matrix motor structure with better performance based on a mirror symmetry principle. Further, the present application also proposes the arrangement principle of the matrix motor composed by the Type B motor elements and the Type A motor elements as shown in FIG. 6, the series and parallel connection scheme of the windings of the motor elements as shown in FIGS. 8 and 9, and the specific mechanical structure implementation scheme of the matrix motor as shown in FIGS. 14 and 16.

According to the technical scheme, the embodiments of the present application provide a matrix motor based on a mirror symmetry principle, which comprises several motor elements; wherein the motor elements are with two types; the motor element type is either a Type A motor element or a Type B motor element; the motor element exterior outlines of the two types are both square or rectangular; the spliced edge connecting two adjacent motor elements can be used as a mirror axis, and the Type A motor elements and the Type B motor elements are symmetrically arranged with respect to the mirror axis; all the motor elements are spliced and arranged to form a matrix motor, and two motor elements that are symmetrical about a mirror axis in the matrix motor are with opposite types. The application provides a novel matrix motor topological structure based on a mirror symmetry principle, aiming at the problems of the existing matrix motor that the mutual coupling of various motor elements is weak (only coupling part of magnetic field components, unable to fully achieve magnetic field coupling), the output torque is weak, the arrangement is not compact enough, the transmission mechanism of various motor elements is complex, and the electromagnetic scheme among all motor elements is imperfect. The topological structure of the matrix motor has the advantages of compact structure, strong coupling, large output torque and simple transmission, and the production and control of the matrix motor are simpler and more convenient by optimizing the electromagnetic scheme between the motor elements.

One of ordinary skill in the field can appreciate that the embodiments described above are specific embodiments for implementing the present application, and various changes in form and details may be made therein without departing from the spirit and scope of the present application. Any technical personnel in this field may make their own changes and modifications without departing from the spirit and scope of this application. Therefore, the scope of protection of this application should be subject to the scope limited by the claims.

What is claimed is:

1. A matrix motor based on a mirror symmetry principle, comprising several motor elements,
wherein the motor elements are with two types; the motor element types are either Type A motor elements or Type B motor elements;
a spliced edge connecting two adjacent motor elements is used as a mirror axis, and the Type A motor elements and the Type B motor elements are symmetrically arranged with respect to the mirror axis; and
all the motor elements are spliced and arranged to form a matrix motor, and two motor elements that are symmetrical about the mirror axis in the matrix motor are with opposite types.

2. The matrix motor based on the mirror symmetry principle according to claim 1, wherein each motor element in the matrix motor is of opposite type with respect to its adjacent motor element, and each motor element in the matrix motor is of the same type as its diagonal motor element.

3. The matrix motor based on the mirror symmetry principle according to claim 1, wherein an exterior outline of each motor element is square or rectangular, and
an exterior outline of a matrix motor formed by several mutually spliced motor elements is a rectangle or a combination of several rectangles.

4. The matrix motor based on the mirror symmetry principle according to claim 1, wherein the mirror axis mirrors a Type B motor element stator part into a Type A motor element stator part, or mirrors the Type A motor element stator part into the Type B motor element stator part, and through synthesis and coupling of a magnetic field generated by each motor element in the matrix motor, some stator yokes are removed and an output torque of a rotor is increased at the same time.

5. The matrix motor based on the mirror symmetry principle according to claim 1, wherein the stator part of the motor element is formed by encircling several half-teeth of the motor element stator; a motor element stator's half-tooth slot is between two motor element stators' half-teeth; and
several half-teeth of the motor element are enclosed to form a stator-module with a circular hole inside and a square or rectangular exterior outline, and the motor rotor is enclosed at a center of a stator-module; and the stator-module enclosed by half-teeth of the motor element is coaxial with the rotor.

6. The matrix motor based on the mirror symmetry principle according to claim 5, wherein the motor element further comprises a front end-cover, a rear end-cover, a front bearing, a rear bearing and a set of motor element winding, the motor element winding is divided into several phases and wrapping on half-teeth of the motor element;
the front end-cover and the rear end-cover are provided with end-cover protruding parts, and the end-cover protruding parts are inserted into half-tooth slots of the motor element to realize the mutual fixation among the front end-cover, the rear end-cover and different half-teeth; and
the front and rear bearings are set in the cavities in the front end-cover and the rear end-cover respectively to realize the free rotation of the rotor around the shaft and limit the rotor radial and axial positions.

7. The matrix motor based on the mirror symmetry principle according to claim 6, wherein the motor element phase windings' magnetic field directions of the corresponding windings in Type B and Type A motor elements are opposite with respect to their rotors when the forward current of the matrix motor is applied to the windings; and the Type B and Type A motor elements' rotor rotation directions are opposite to each other; and when the rotors' magnetic poles of motor elements are all aligned with A-phase at the initial state, the rotor pole polarities in Type B and Type A motor elements aligned with A-phase are opposite.

8. The matrix motor based on the mirror symmetry principle according to claim 6, wherein the connection mode of each phase winding of each motor element is series connection, parallel connection or series-parallel connection.

9. The matrix motor based on the mirror symmetry principle according to claim 1, wherein after each motor element is symmetrical about a mirror axis, the motor element can rotate around the mirror axis by a certain angle in space to realize a spatial structure; and magnetic conductive materials are arranged between the half-teeth of the two adjacent motor elements to realize the coupling of the magnetic fields of the two motor elements.

10. The matrix motor based on the mirror symmetry principle according to claim 1, wherein the motor elements are matched and synchronized with each other via gears, magnetic gears, magnetic coupling, belt pulleys, friction or chains, so that the torques of the motor elements are gathered together to realize the synchronous rotation of the motor element rotors.
